(19) United States
(12) Patent Application Publication
(10) Pub. No.: US 2005/0237485 A1
(43) Pub. Date: Oct. 27, 2005

(54) Method and apparatus for correcting vision

(76) Inventors: Ronald D. Blum, Roanoke, VA (US); William Kokonaski, Gig Harbor, WA (US); Dwight P. Duston, Laguna Niguel, CA (US)

Correspondence Address: J. Michael Martinez de Andino, Esq.;HUNTON & WILLIAMS LLP, Riverfront Plaza, East Tower, 951 E. Byrd Street, Richmond, VA, 23219-4074, US

(21) Appl. No.: 11/109,360

(22) Filed: Apr. 19, 2005

Related U.S. Application Data
(60) Provisional application No. 60/563,890, filed on Apr. 21, 2004.

(51) Int. Cl. G02C 7/04; G02C 7/06

(52) U.S. Cl. 351/168

(57) ABSTRACT

Dynamic reading glasses are disclosed, whereby the glasses sense whether a reader is trying to view an object near or at a distance, and the dynamic reading glasses modify the lenses' optical power accordingly. In certain embodiments, the modification of the lenses' optical power may be accomplished through an electro-active material.

This application claims the benefit of U.S. Provisional Application No. 60/563,890 filed Apr. 21, 2004. U.S. Provisional Application No. 60/563,890 is herein incorporated by reference in its entirety.

### FIELD OF THE INVENTION

The present invention relates to the field of vision correction, more particularly to dynamic reading glasses, whose optical power may be adjusted according to whether the wearer is attempting to focus on an object near or at a distance.

### SUMMARY OF THE INVENTION

It is well known that 93% of all humans over the age of forty (40) years suffer from a condition known as presbyopia. This condition is caused by a lack of accommodative focusing power of the eye and more specifically the lens within the eye. It is believed that the mechanism that creates this loss of accommodation actually begins very early in life and it is only at approximately age forty (40) years when the effect becomes obvious to the presbyopic individual. The impact or visual effect on the presbyopic individual is a reduction in one's focusing power at near. The way a presbyopic individual tries to compensate for this reduction in focusing power is to simply move the near target that he or she is trying to focus on further from their eyes. Thus presbyopia is sometimes referred to as the “extension arm syndrome”.

Spectacle lenses have been used to correct for presbyopia for hundreds of years. Monocles, reading glasses, bifocals, progressive addition lenses, and half eyes are all examples of lenses used to correct or compensate for this condition. Benjamin Franklin is widely credited with inventing bifocals. Bifocals enable the presbyopic wearer to focus both in the distance and also near with the same device. However, monocles, reading glasses and half eyes only allow the presbyopic wearer to focus at near. If an individual, wearing reading glasses looks far away his or her distance vision is very blurred. Likewise, if a wearer of half eyes does not wear the half eyes down on their nose so that they can look over them, the wearer also cannot see far away, as their distance vision is very blurred. One disadvantage of bifocals is that you have a line indicating the presence of the near power. Another is that the wearer cannot look through the reading zone and see distant objects clearly, which can be a particular problem walking down stairs, for example. Yet another disadvantage of bifocals is that there is a persistent image jump when one moves their eye from distance zone to near zone and visa versa. Furthermore, bifocals provide no intermediate vision correction. The present invention addresses all of these issues since the reading power can be turned on and off leaving the fixed lens to be either intermediate power or purely distance power.

Thus, there is a need for a monocle, reading glass or half eye that will allow for the wearer to see both far and near through the focal point on a lens. It is an object of the present invention to solve this nagging deficiency.

In an exemplary embodiment of the invention, a view detector located on the frame or the lens may sense whether the wearer is attempting to focus on an object at a near distance or a far distance, and varies the optical power of the lens accordingly.

In another exemplary embodiment, the optical power of the lens may vary across the a portion of lens, in addition to being capable of being modified when the wearer changes focus distance.

Aspects of the present invention will now be described in more detail with reference to exemplary embodiments thereof as shown in the appended drawings.

### BRIEF DESCRIPTION OF THE DRAWINGS

FIG. 1 is a front view of one embodiment of dynamic reading glasses.

FIGS. 2A-2B are section views of a lens in a pair of dynamic reading glasses.

FIG. 3 is a front view of an embodiment of dynamic reading glasses.

FIG. 4 is a front view of an alternate embodiment of dynamic reading glasses.

### DETAILED DESCRIPTION OF PREFERRED EMBODIMENTS

The reading glasses or half eyes of the present invention allow the wearer when looking at far to have their reading prescriptions dynamically switch so that the wearer can focus on an object in the distance.

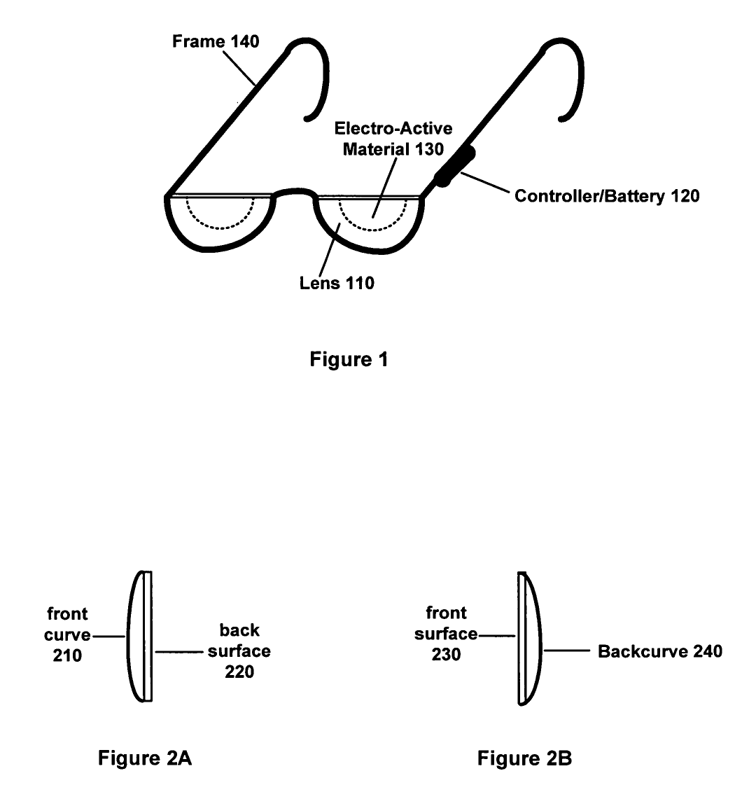

FIG. 1 is a front view of one embodiment of dynamic reading glasses. Frame 140 may contain lens 110, which may have a portion of electro-active material 130 applied thereto. The electro-active material 130 may be controlled and powered by a controller/battery 120 attached to the frame 140. The electro-active material 130 may switch its optical power as directed by the controller.

The switching as directed by the controller may be enabled by using a view detector 150, such as, by way of example only, a tilt switch, micro-gyroscope, range finder or eye tracking device which is mounted or housed either on or in the lens, or in the eye glass frame housing the individual's reading prescription lenses. When view detector 150 senses by the position of the person's head (tilt switch) or by a signal received by a range finder or by the position of the reader's eyes from an eye tracker or a combination of these mechanisms, that the presbyopic individual wearing the reading prescription is no longer reading at near, the sensor alerts the controller/battery 120.

The sensing in the case of a tilt switch may be activated when the wearer looks up to see at the distance and thus the eye glass temples change their orientation to the vertical. In the event that eye tracking is used, a tracking means measures the convergence of the wearer's pupils. Obviously, the closer the two pupils are together the more likely the wearer is reading and the further apart the pupils are, the more likely the pupils are looking into the distance. Finally, the use of a range finder could be used to measure the distance at which the wearer is focusing.

The dynamic lens switching may be performed by utilizing an electro-active lens or lenses that have the ability to switch their optical power as directed by a micro-controller depending upon the visual target which the individual is viewing. The disclosures of U.S. Pat. No. 6,491,391, U.S. Pat. No. 6,491,394, U.S. Pat. No. 6,517,203, U.S. Pat. No. 6,619,799 and U.S. Published Patent Application Nos. 2002-0140899, 2003-02210377, 2003-0058406, 2003-0231293, 2004-0027501, 2004-0027536, 2004-0056986, and 2004-0051846 are herein incorporated by reference. These disclosures teach electro-active lenses that take into account an individual's distance prescription and switches it dynamically to a near prescription, thus leaving in many, if not most cases, an optical power in the eyeglasses. The current inventive embodiment does the opposite and switches the reading lens prescription to plano or no optical power. In certain other embodiments, the reading lens power switches to that of an intermediate power and also to that of no power. In each of these embodiments, when the lens or lenses switch to no optical power it allows for the wearer to see in the distance.

Most people who suffer from presbyopia still have some reserve accommodative (i.e. variable) power, but the magnitude of this power is not large enough for them to read or see near objects without straining, squinting, or holding the object far way from their eye. It should also be pointed out that in certain cases of accommodative insufficiency muscle imbalance, or learning disorders pre-presbyopic individuals are given reading glasses or half eyes to compensate or correct their particular disorders. These pre-presbyopic individuals are also helped by the present invention as they do not have a distance prescription and generally do not require a distance prescription when looking at far. Thus, these particular pre-presbyopic individuals also need to take their reading glasses off to see in the distance. The present invention allows these pre-presbyopic individuals, as well as the presbyopic individuals who do not need to wear a prescription to see in the distance utilizing their reading glasses or half eyes for both far and near without having to take their eye glasses off or re-orient them on their nose in an effort to see over them.

In another inventive embodiment, the inventive reading glasses or half eyes are configured to allow for an intermediate power which allows for focusing at an intermediate target, such as by way of example only, a computer screen. In this case, the inventive reading glasses or half eyes can dynamically switch to that of only an intermediate power or to both plano (no optical power) and also separately to that of an intermediate power. Once again the determination of the working distance is determined as before, by way of example only, a tilt switch, range finder, eye tracker, micro-gyroscope.

In one embodiment of the present invention the lens 110 may have an optical power of +2.00 diopters. Based upon the head position of the wearer, the controller/battery 120 may determine that the wearer wishes to read. The electro-active material 130 may then be switched off and the entire lens 110 may then have an optical power of +2.00 diopters. When the controller/battery 120 determines that the wearer wishes to focus on an object in the distance, the controller/battery 120 may send a signal to the electro-active material 130 to provide an optical power of −2.00 diopters.

In another embodiment of the present invention, the lens 110 may have no optical power. Based upon the head position of the wearer, input from a range finder device, or manual switch, the controller/battery 120 may determine that the wearer wishes to read. The electro-active material 130 may then be switched on and the electro-active material 130 may provide an optical power of +2.00 diopters. When the controller/battery 120 determines that the wearer wishes to focus on an object in the distance, the controller/battery 120 may send a signal to turn off the electro-active material 130 to provide no optical power.

In yet another embodiment of the present invention, the lens 110 may have an optical power of +1.00 diopters. However, the wearer may require an optical power of +2.0 diopters for reading. Based upon the head position of the wearer, the controller/battery 120 may determine that the wearer wishes to read. The electro-active material 130 may then be switched on and the electro-active material 130 may provide an additional +1.00 diopters of optical power. Thus, the total optical power provided to the wearer is +2.00 diopters. When the controller/battery 120 determines that the wearer wishes to focus on an object in the distance, the controller/battery 120 may send a signal to the electro-active material 130 to provide an optical power of −1.00 diopters. When combined with the +1.00 diopter optical power of the lens 110, the effect to the wearer of the frame 140 is to provide no optical power, or plano power. When the controller/battery 120 determines that the wearer wishes to focus on an intermediate object, such as a computer screen, the electro-active material 130 is turned off, thereby producing no optical power. Thus, the wearer of the frame 140 is provided +1.00 diopters of optical power for focusing on the intermediate object.

FIGS. 2A and 2B are section views of a lens in a pair of dynamic reading glasses. The present invention allows for applying the electro-active lens to that of a flat surface. Wherein the opposite side of the base lens from which the electro-active lens is applied is always curved. In FIG. 2A, the electro-active material may be applied to back surface 220 instead of front curve 210; in FIG. 2B, the electro-active material may be applied to front surface 230 instead of back curve 240. By utilizing this inventive approach it is possible to reduce the number of SKUs (stock keeping units) and to easily assemble/fabricate the lenses of the invention. The electro-active lenses may be flat so you don't have multiple skus with different curvatures only the fixed lens changes curvatures as you change the base (or constant) power of the lens.

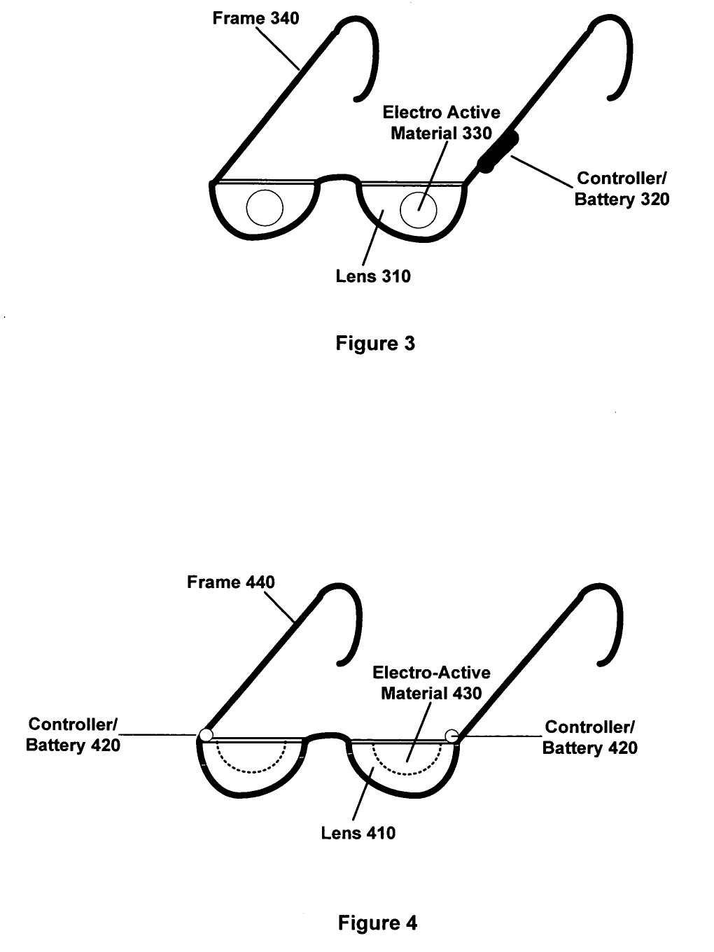

FIG. 3 is a front view of an alternate embodiment of dynamic reading glasses. Frame 340 may contain lens 310, which may have a portion of electro-active material 330 applied thereto. The amount and exact position of the electro-active material 330 on the lens 310 may vary. The electro-active material 330 may be controlled and powered by a controller/battery 320 attached to the frame 340. The switching as directed by the controller may be enabled by using a view detector 350.

FIG. 4 is a front view of an alternate embodiment of dynamic reading glasses. Frame 440 may contain lens 410, which may have a portion of electro-active material 430 applied thereto. The electro-active material 430 may be controlled and powered by a controller/battery 420 attached to the frame 440. The electro-active material 430 may switch its optical power as directed by the controller/battery 420. The controller/battery 420 can be incorporated within the lens, on or in the temple, or attached to the hinge screw or contained within the interior area closest to the wearer's face where the frame temple meets the front eye wire of the frame. The power sources can be, by way of example only, a battery which can be rechargeable or disposable, a fuel cell, or a solar cell.

It should also be pointed out that unlike prior art, the present invention teaches the electro-active optical power may be switched off, in certain cases, so that the base lens power of the reading glasses or half eyes provides the reading correction required by the wearer. In this case the electro-active element will provide no additional power and thus will allow the original optical power of the base lens to provide the reading power needed for the wearer. By doing this it has been discovered that it is possible to enlarge the viewing area or the reading optic to that of the full lens contained within the frame. This the opposite of what is taught in the prior art, whether using a conventional lens (static optic) or that of an electro-active lens (dynamic optic), with regards to correcting presbyopia with lenses capable of producing more than a single focal length. For example, the reading area of a PAL or bifocal typically makes up less than 50% of the lens area.

In the present invention only when one looks at far is the lens or lenses switched to that of plano or no optical power. In this case the electro-active region or zone will create a power that is approximately the same, if not an identical power as that of the base lens, but opposite in sign to that of the base lens. By way of example only, if the base lens provided a +2.00 D power, then the electro-active region or zone would create a −2.00 D power. However, when looking near the electro-active region or zone of the present invention would provide no optical power. Thus the present invention allows for the full use of the reading lens area (the electro-active lens plus that of the reading base lens) and only allows for being restricted to seeing within the electro-active lens area when looking at either an intermediate target or a distance target. As can be seen in the following figures of the invention the switching portion of the electro-active lens is always contained within the perimeter of the base lens.

In still other embodiments the base lens power may be that of the intermediate power (which is typically 50% or half the required reading correction). In this case, the electro-active lens can be activated to produce additional power that may be used to increase the power of the base lens to allow for reading correction, or the electro-active lens may be activated in such a manner as to produce a negative power equal to the base power of the lenses that would result in a window of no optical power that can be used to allow the wearer to view objects in the distance.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

1. Reading glasses that enable a wearer to see at a near distance, an intermediate distance and a far distance while looking through a lens having a fixed focal length at the near distance.

2. The reading glasses of claim 1 wherein the reading glasses are half eyes.

3. The reading glasses of claim 1 wherein the reading glasses are full reading glasses.

4. The reading glasses of claim 1 further comprising an electro-active material.

5. The reading glasses of claim 1 further comprising a tilt switch.

6. The reading glasses of claim 1 further comprising a power source.

7. The reading glasses of claim 1 further comprising a controller.

8. The reading glasses of claim 1 further comprising a range finder.

9. Reading glasses that enable a wearer to see at a far distance while looking through a lens having a fixed focal length at the near distance.

10. The reading glasses of claim 9 wherein the reading glasses are half eyes.

11. The reading glasses of claim 9 wherein the reading glasses are full reading glasses.

12. The reading glasses of claim 9 further comprising an electro-active material.

13. The reading glasses of claim 9 further comprising a tilt switch.

14. The reading glasses of claim 9 further comprising a power source.

15. The reading glasses of claim 9 further comprising a controller.

16. The reading glasses of claim 9 further comprising a range finder.

17. Reading glasses that enable a wearer to see at an intermediate distance while looking through a lens having a fixed focal length at the near distance.

18. The reading glasses of claim 17 wherein the reading glasses are half eyes.

19. The reading glasses of claim 17 wherein the reading glasses are full reading glasses.

20. The reading glasses of claim 17 further comprising an electro-active material.

21. The reading glasses of claim 17 further comprising a tilt switch.

22. The reading glasses of claim 17 further comprising a power source.

23. The reading glasses of claim 17 further comprising a controller.

24. The reading glasses of claim 17 further comprising a range finder.

25. Intermediate reading glasses that enable a wearer to focus at a near distance while looking though a lens having a fixed focal length at an intermediate distance.

26. The intermediate reading glasses of claim 25 wherein the intermediate reading glasses are half eyes.

27. The intermediate reading glasses of claim 25 wherein the intermediate reading glasses are full reading glasses.

28. The intermediate reading glasses of claim 25 further comprising an electro-active material.

29. The intermediate reading glasses of claim 25 further comprising a tilt switch.

30. The intermediate reading glasses of claim 25 further comprising a power source.

31. The intermediate reading glasses of claim 25 further comprising a controller.

32. The intermediate reading glasses of claim 25 further comprising a range finder.

33. Intermediate reading glasses that enable a wearer to see at a far distance while looking through a lens having a fixed focal length at an intermediate distance.

34. The intermediate reading glasses of claim 33 wherein the intermediate reading glasses are half eyes.

35. The intermediate reading glasses of claim 33 wherein the intermediate reading glasses are full reading glasses.

36. The intermediate reading glasses of claim 33 further comprising an electro-active material.

37. The intermediate reading glasses of claim 33 further comprising a tilt switch.

38. The intermediate reading glasses of claim 33 further comprising a power source.

39. The intermediate reading glasses of claim 33 further comprising a controller.

40. The intermediate reading glasses of claim 33 further comprising a range finder.

41. A method for correcting vision, comprising:
providing a lens with fixed static optical power to correct at least a portion of a wearer's near or intermediate focusing needs; and
dynamically altering the fixed static optical power of the lens to achieve a different focal length for the wearer.

42. The method of claim 41 further comprising:
providing power to the portion of the lens.

43. The method of claim 41 further comprising:
switching off the provision of power to the portion of the lens.
